(19) United States
(12) Patent Application Publication
(10) Pub. No.: US 2013/0250637 A1
(43) Pub. Date: Sep. 26, 2013

(54) Single-Stage Single-Switch Voltage Converter

(71) Applicants: Ching-Tsai Pan, Hsinchu City (TW); Yu-Hsiang Lee, Hsinchu City (TW); Po-Yen Chen, Hsinchu City (TW)

(72) Inventors: Ching-Tsai Pan, Hsinchu City (TW); Yu-Hsiang Lee, Hsinchu City (TW); Po-Yen Chen, Hsinchu City (TW)

(73) Assignee: NATIONAL TSING HUA UNIVERSITY, Hsinchu City (TW)

(21) Appl. No.: 13/426,119

(22) Filed: Mar. 21, 2012

(51) Int. Cl. G05F 3/08; H02M 7/06

(52) U.S. Cl. 363/126; 323/311

(57) ABSTRACT

The present invention is a single-stage voltage converter. With only one switch, a higher DC (direct current) voltage at input end is converted into a lower DC voltage at output end. Thus, a lower-voltage load is provided with the lower DC voltage. The present invention is characterized in power factor correction and high step down voltage ratio. The present invention can be applied to multiple DC pairs.

### TECHNICAL FIELD OF THE INVENTION

The present invention relates to a voltage converter; more particularly, relates to converting a high-voltage power to a low-voltage power for providing energy to a low-voltage load with a DC (direct-current) bus capacitor having a small capacitance.

### DESCRIPTION OF THE RELATED ARTS

In FIG. 12, a general non-isolated step down voltage converter is an ideal basic step down voltage converter, comprising a control integrated-circuit IC, an active semiconductor power switch SW, a diode D, an energy-storing inducer L and a capacitor C. When the active semiconductor power switch SW is turned on, a power source charges the energy-storing inducer L and simultaneously charges the capacitor C for providing energy to an output load. When the active semiconductor power switch SW is turned off, the energy-storing inducer L charges the capacitor C with its stored energy through the diode D and simultaneously provides energy to the output load.

When the active semiconductor power switch SW is turned on, the increase Δi_{L(on)} in current of the inducer has the following equation:

$$Δ {i}_{L ( on )} = \frac{{v}_{in} - {v}_{0}}{L} {D}_{on} {T}_{S} \qquad ( 31 )$$

Therein, Tₛ is a switching cycle; and, Dₒₙ is a duty cycle when a power crystal is turned on. When the active semiconductor power switch SW is turned off, the increase Δi_{L(on)} in current of the inducer has the following equation:

$$Δ {i}_{L ( off )} = \frac{- {v}_{0}}{L} ( 1 - {D}_{on} ) {T}_{S} \qquad ( 32 )$$

According to voltage-second balance principle, the following equation is obtained:

$$\frac{{v}_{in} - {v}_{0}}{L} {D}_{on} {T}_{S} - \frac{{v}_{0}}{L} ( 1 - {D}_{on} ) {T}_{S} = 0 \qquad ( 33 )$$

Furthermore, an equation of relationship between an input voltage and an output voltage is obtained:

$$\frac{{v}_{0}}{{v}_{in}} = {D}_{on} \qquad ( 34 )$$

According to equation (34), the duty cycle Dₒₙ determines step down voltage ratio of the step down voltage converter.

Hence, for a higher step down voltage ratio, a smaller Dₒₙ is required. Take stepping down from 311 volts (V) to 12V as an example. Through equation (34), Dₒₙ is figured out as about 0.038. But, owing to limits on physics and control circuit, a good duty cycle is hard to be obtained; and the step down voltage ratio is hard to be an ideal value owing to the physical limits. Besides, a very small duty cycle may produce high-frequency noise and may result in low performance.

Because of the duty cycle limit, multiple stage circuit structures are used in applications having high step down voltage ratios, where a plurality of step down circuits are serially linked to obtain the high step down voltage ratio, as shown in FIG. 13. However, since components used in the structure are not ideal, the step down voltage ratio for each stage is lower than 100% and the final ratio becomes small as is the product of multiplying the ratios of all stages. Besides, in the serially-linked circuits, many extra components and control circuits are required, which adds cost to the converter.

A general step down voltage flyback converter is mainly used in a load below 100 watt (W), as shown in FIG. 14. A flyback inductor in the circuit of the flyback converter is also functioned as an energy-storing inducer; and, a diode and a capacitor are all required for a secondary end. Thus, the flyback converter is very competitive on cost in the market. The flyback converter comprises a control integrated-circuit IC, an active semiconductor power switch SW, a flyback inductor T, a diode D and a capacitor C. By controlling the turning on/off of the active semiconductor power switch SW, energy is stored/released through the magnetic flyback inductor T. With coordination of the diode D and the capacitor C, an output voltage is rectified and filtered. Thus, a DC voltage is outputted. The flyback converter T has three functions, including electronic isolation, voltage variation and energy-storing induction. To strictly say, the flyback converter T is not exactly a transformer, but a couple inducer. Through turning on and turning off the active semiconductor power switch SW, energy stored in the flyback inductor T is transferred to a secondary side of the flyback inductor T for charging the capacitor C through the diode D for maintaining the DC voltage at a certain level. Therein, when the active semiconductor power switch SW is turned on, a voltage source vᵢₙ charges the flyback inductor T and biases the diode D reversely. At the same time, the capacitor C provides energy to an output terminal. Then, when the active semiconductor power switch SW is turned off, the flyback inductor T charges the capacitor C with energy through the diode D for providing energy to the output terminal. Relationship between output voltage and input voltage has the following equation:

$$\frac{{v}_{0}}{{v}_{in}} = \frac{1}{n} \frac{{D}_{on}}{1 - {D}_{on}} \qquad ( 35 )$$

According to operations of the step down voltage converter and the flyback converter, the step down voltage ratio depends on the duty cycle Dₒₙ, where the step down voltage ratio of the flyback converter is related to turns ratio of the flyback inductor. Thus, the flyback converter has a good step down voltage ratio. Yet, the flyback inductor makes the size of the converter big, expensive and not easily circuit-integrated. Besides, for a higher step down voltage ratio, the flyback inductor requires a greater turns ratio owing to the limit of the least duty cycle. In addition, after a secondary energy conversion, the performance on converting would become lower than the non-isolated step down voltage ratio converter. Hence, the prior arts do not fulfill all users' requests on actual use.

### SUMMARY OF THE INVENTION

The main purpose of the present invention is to provide a voltage converter to convert a higher DC voltage at input end into a lower DC voltage at output end with power factor correction and high step down voltage ratio.

The second purpose of the present invention is to provide a single-stage step down voltage converter using a DC bus capacitor having a small capacitance, instead of using an electrolytic capacitor.

The third purpose of the present invention is to applying a converter to multiple DC pairs while using only one active switch for reducing number of components used in the converter for saving cost and enhancing performance.

To achieve the above purposes, the present invention is a single-stage single-switch voltage converter, comprising three inducers, three capacitors, two diodes and one active semiconductor power switch, where the converter converts a high-voltage power into a low-voltage power for providing power to a low-voltage load; the inducers comprises a first, a second and a third inducers; the capacitors comprises a first, a second and a third capacitors; the diodes comprises a first and a second diodes; two terminals at an input end of the converter are connected with a serial circuit; the serial circuit comprises the first inducer, the first capacitor and the second inducer; a positive voltage terminal and a negative voltage terminal of the first capacitor are connected with the active semiconductor power switch and the first diode, respectively, to connect to a first terminal of the third inducer; the first terminal of the third inducer is connected with the second capacitor and the second diode to connect to a common negative terminal of the input end and an output end of the converter; the third capacitor is connected with another terminal of the third inducer and the negative voltage terminal at the output end of the converter; and the another terminal of the third inducer is connected with the positive voltage terminal at the output end of the converter.

When the active semiconductor power switch is turned off, the first diode is turn on; a current of the first inducer charges the first capacitor with energy provided by the second inducer and the third inducer; the energy is rapidly increased through a voltage at the first capacitor and a current passed through the first inducer is limited to zero; and a high step down voltage ratio is thus obtained with power factor correction.

When the active semiconductor power switch is turned on, the first diode is turned off; the first capacitor charges the second inducer; the first inducer stores energy; when the first capacitor finishes releasing energy, the second diode is turned off and the second inducer transfers energy to the second capacitor and the third inducer; and, until the active semiconductor power switch is turned on again, a switching cycle is completed.

Accordingly, a novel single-stage single-switch voltage converter is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is the general circuit view showing the preferred embodiments according to the present invention;

FIG. 2 is the view showing the first preferred embodiment;

FIG. 3 is the view showing the second preferred embodiment;

FIG. 4 is the view showing the third preferred embodiment;

FIG. 5 is the view showing the equivalent circuit operated in the first state-of-use;

FIG. 6 is the view showing the equivalent circuit operated in the second state-of-use;

FIG. 7 is the view showing the equivalent circuit operated in the third state-of-use;

FIG. 8 is the view showing the equivalent circuit operated in the fourth state-of-use;

FIG. 9 is the view showing the equivalent circuit operated in the fifth state-of-use;

FIG. 10 is the first view showing the simulated key waves;

FIG. 11 is the second view showing the simulated key waves;

FIG. 12 is the view of the first prior art;

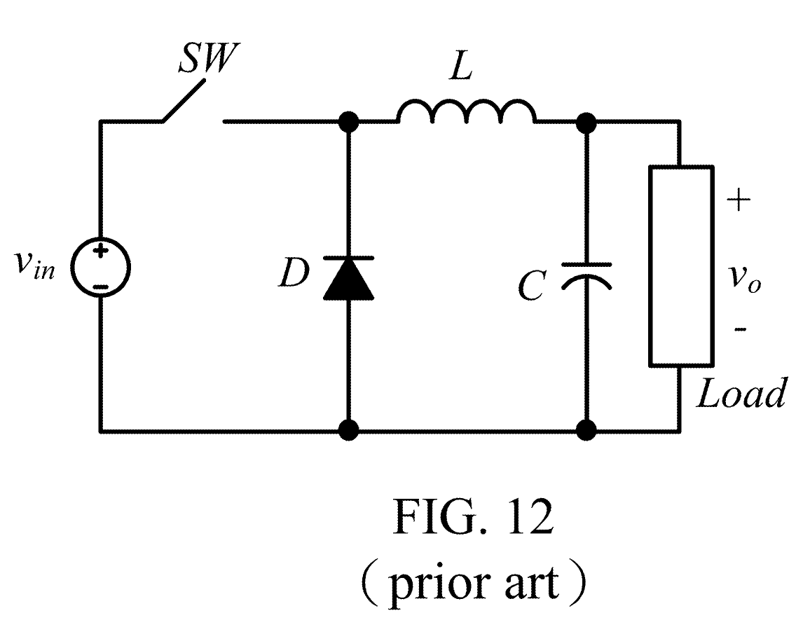

FIG. 13 is the view of the second prior art; and

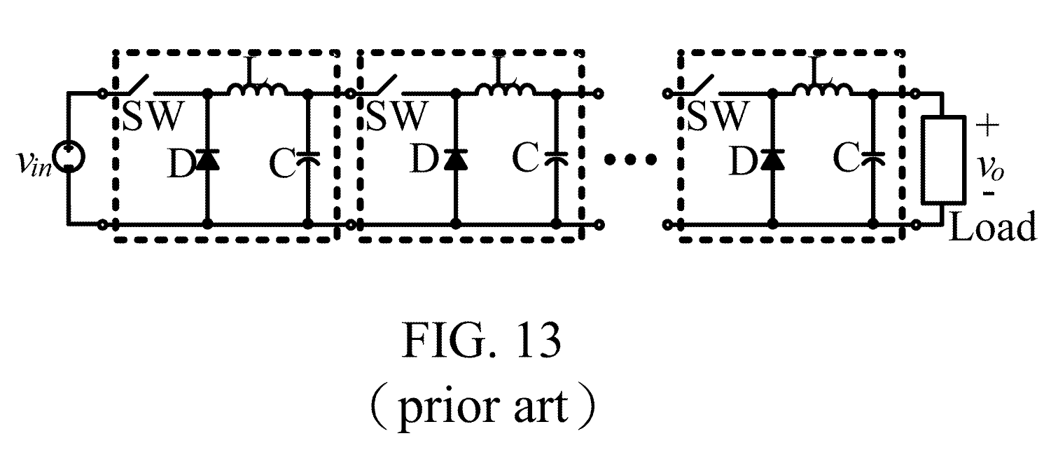

FIG. 14 is the view of the third prior art;

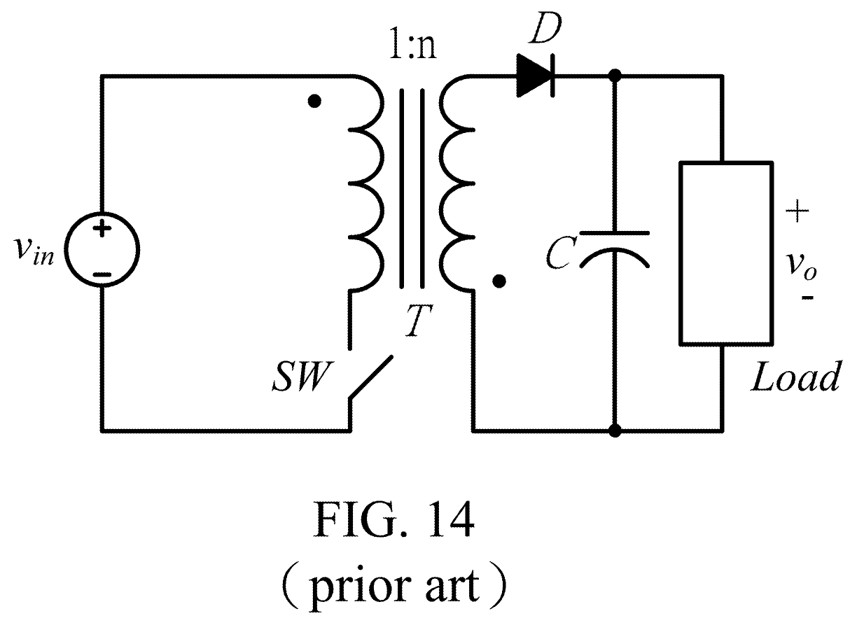

### DESCRIPTION OF THE PREFERRED EMBODIMENTS

The following descriptions of the preferred embodiments are provided to understand the features and the structures of the present invention.

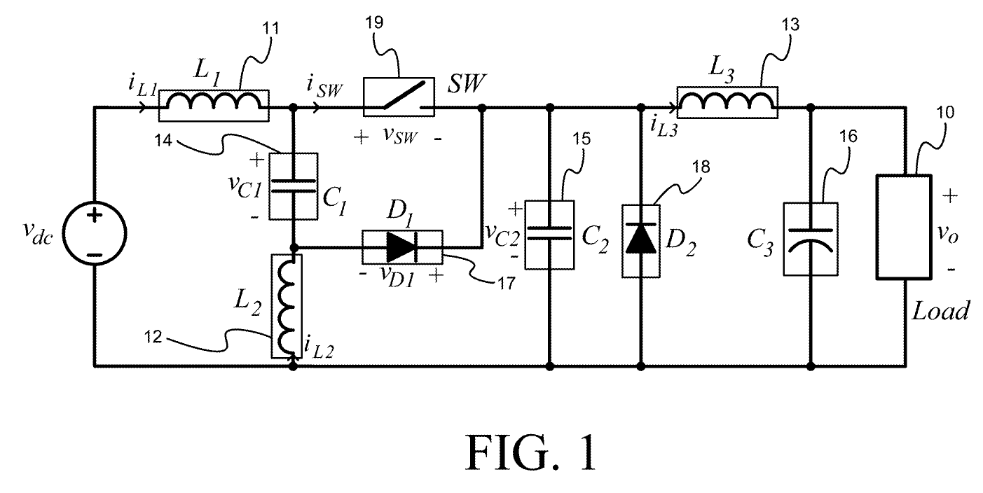

Please refer to FIG. 1 to FIG. 4, which are a general circuit view showing preferred embodiments according to the present invention and views showing a first preferred embodiment, a second preferred embodiment and a third preferred embodiment. As shown in the figures, the present invention is a single-stage single-switch voltage converter, where the converter converts a high-voltage power into a low voltage power for providing energy to a low-voltage load [10]. The converter comprises three inducers (a first inducer L₁ [11], a second inducer L₂ [12] and a third inducer L₃ [13]), three capacitors (a first capacitor C₁ [14], a second capacitor C₂ [15] and a third capacitor C₃ [16]), two diodes (a first diode D₁ [17] and a second diode D₁ [18]) and an active semiconductor power switch SW [19]. Therein, two terminals at an input end of the converter are connected with a serial circuit and the serial circuit comprises the first inducer [11], the first capacitor [14] and the second inducer [12]; a positive voltage terminal and a negative voltage terminal of the first capacitor [14] are connected with the active semiconductor power switch [19] and the first diode [17], respectively, to connect to a first terminal of the third inducer [13]; the first terminal of the third inducer [13] is connected with the second capacitor [15] and the second diode [18] to connect to a common negative terminal of the input end and an output end of the converter; the third capacitor [16] is connected with another terminal of the third inducer [13] and the negative voltage terminal at the output end of the converter; and, the another terminal of the third inducer [13] is connected with the positive voltage terminal at the output end of the converter. Thus, a novel single-stage single-switch voltage converter is obtained with good performance and high step down voltage ratio.

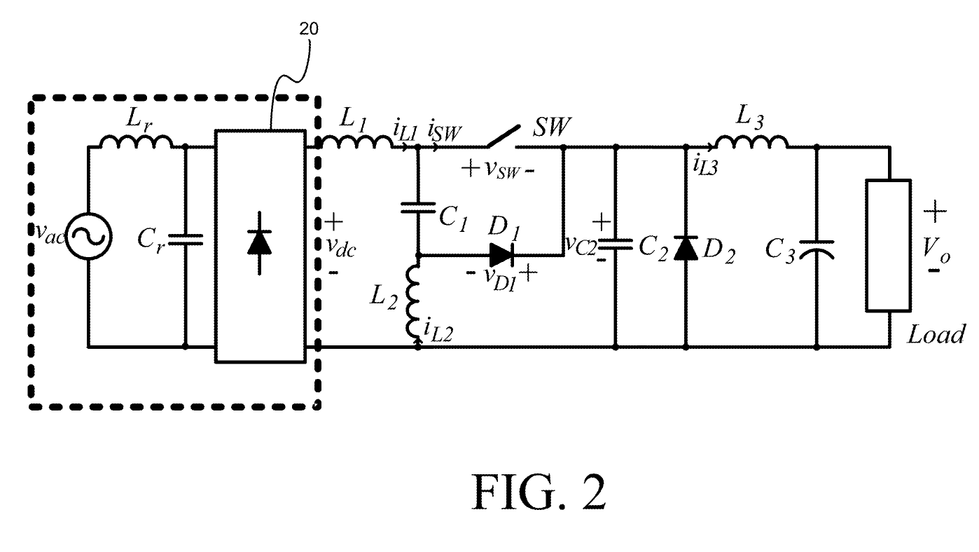

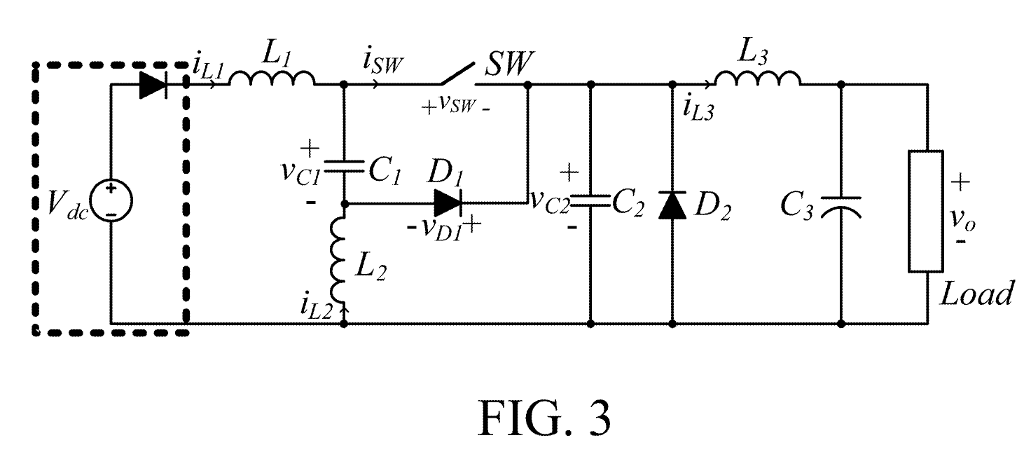

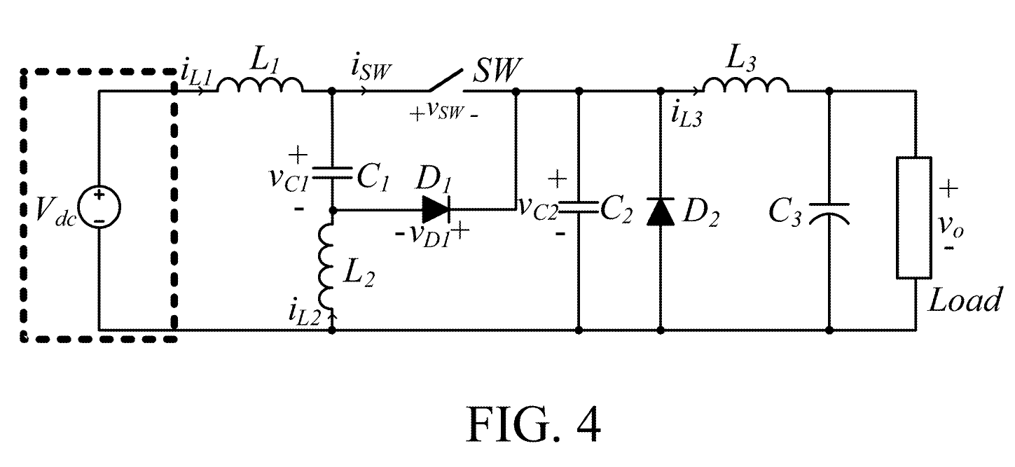

When the converter is used with an alternative current (AC) power source, a diode bridge rectifier [20] is used to change a voltage waveform of the converter into a waveform of absolute value of sine. Therein, an output current of the converter is always positive and the first inducer L₁ is operated with an input current having non-continuous conduction. Thus, power factor correction is achieved, as shown in FIG. 2. When the converter is used with a direct current (DC) power source, an output current of the power source is always positive with a circuit design as shown in FIG. 3. In the other hand, with a design of parameters of circuit components, the circuit of the present invention makes input inducer be operated under continuous conduction for reducing current ripple at input end, as shown in FIG. 4.

The present invention is operated in the following ways: When the active semiconductor power switch SW is turned off, the first diode D₁ is turn on; a current of the first inducer L₁ charges the first capacitor C₁ with energy provided by the second inducer L₂ and the third inducer L₃. Because the first capacitor C₁ has a small capacitance (i.e. smaller than 10 microfarad (μF)), the energy at terminal is rapidly increased through a voltage at the first capacitor C₁; and a current passed through the first inducer L₁ is limited to zero. Thus, a high step down voltage ratio is obtained with power factor correction.

Then, when the active semiconductor power switch SW is turned on, the first diode D₁ is turned off; the first capacitor C₁ starts to charge the second inducer L₂; and the first inducer L₁ starts to store energy. When the first capacitor C₁ finishes releasing energy, the second diode D₂ is turned off and the second inducer D₂ transfers energy to the second capacitor C₂ and the third inducer L₃. Until the active semiconductor power switch SW is turned on again, a switching cycle is completed.

The following state-of-uses assume that all of the electric components the present invention uses are ideal with DC voltage source where output power is always positive. In addition, it is assumed that a load used in the present invention is a pure resistance R_{L}.

### [State-of-Use 1]

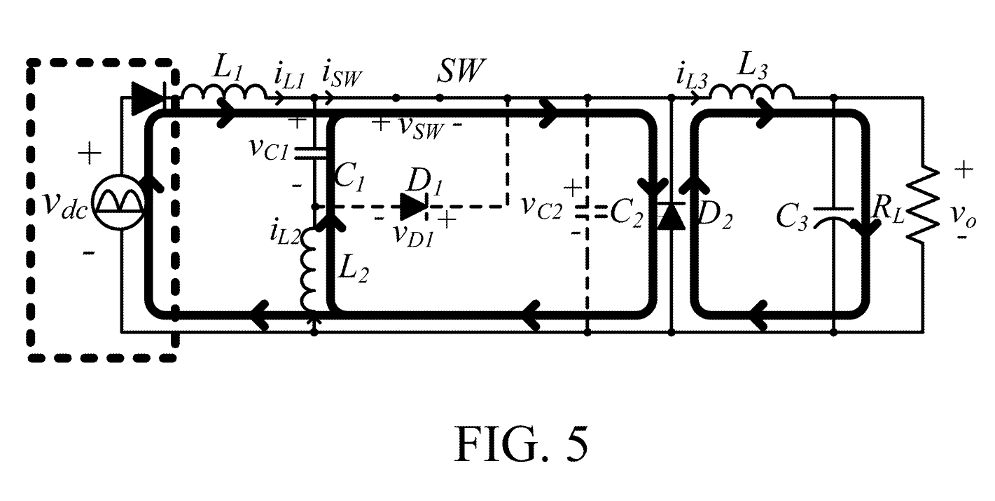

Please refer to FIG. 5, which is a view showing an equivalent circuit operated in a first state-of-use. As shown in the figure, an active semiconductor power switch SW is turned on; a first diode D₁ is turned off; a first capacitor C₁ transfers stored energy through a second diode D₂ to a second inducer L₂; at the same time, a first inducer L₁ stores energy by adding voltage through the power source v_{dc}; and, the third inducer L₃ provides energy through the second diode D₂ to a load R_{L}. According to FIG. 5, the following equations (1) to (6) are obtained. Therein, v_{dc} is an input voltage; i_{L1} is a current on the first inducer L₁; i_{L2} is a current on the second inducer L₂; i_{L3} is a current on the third inducer L₃; i_{SW} is a current on the active semiconductor power switch SW; v_{C1} is a voltage on the first capacitor C₁; v_{C2} is a voltage on a second capacitor C₂; v_{C3} is a voltage on a third capacitor C₃; v_{SW} is a voltage on the active semiconductor power switch SW; and, v_{D1} is a voltage on the first diode D₁. When the first capacitor C₁, finishes releasing energy, the present invention enters into a second state-of-use.

$$\begin{matrix}{L}_{1} \frac{d {i}_{L 1}}{d t} = {v}_{dc} & ( 1 ) \\ {L}_{2} \frac{d {i}_{L 2}}{d t} = {v}_{C 1} & ( 2 ) \\ {L}_{3} \frac{d {i}_{L 3}}{d t} = - {v}_{o} & ( 3 ) \\ {C}_{1} \frac{d {v}_{C 1}}{d t} = - {i}_{L 2} & ( 4 ) \\ {C}_{2} \frac{d {v}_{C 2}}{d t} = 0 & ( 5 ) \\ {C}_{3} \frac{d {v}_{C 3}}{d t} = {i}_{L 3} - \frac{{V}_{o}}{{R}_{L}} & ( 6 )\end{matrix}$$

### [State-of-Use 2]

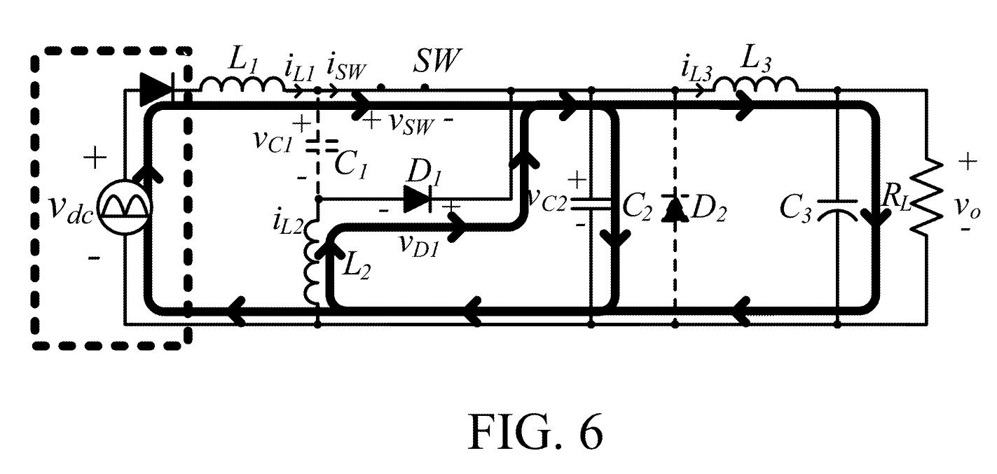

Please further refer to FIG. 6, which is a view showing an equivalent circuit operated in the second state-of-use. As shown in the figure, the first diode D₁ is turned on; a second diode D₁ is turned off; and, the first inducer L₁ and the second inducer L₂ both transfer stored energy to a second capacitor C₂ and the load R_{L}. According to FIG. 6, the following equations (7) to (12) are obtained. When the active semiconductor power switch SW is turned off, the present invention enters into a third state-of-use.

### [State-of-Use 3]

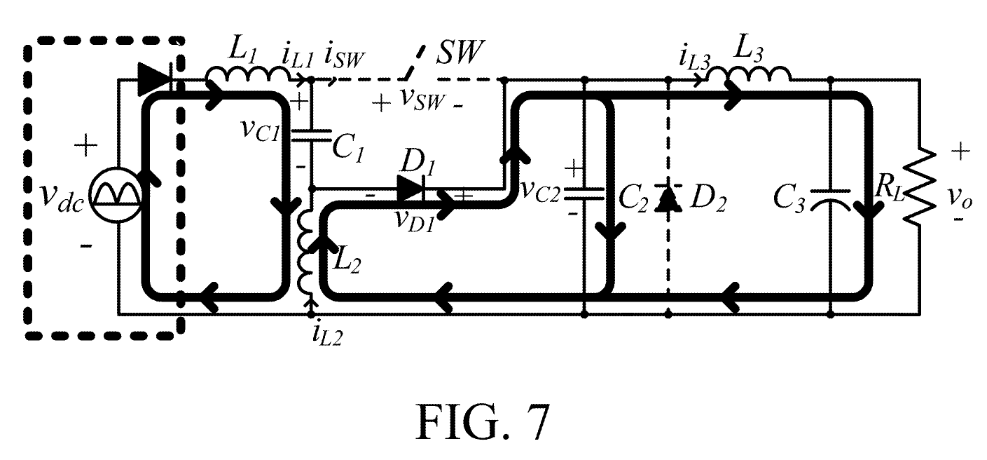

Please further refer to FIG. 7, which is a view showing an equivalent circuit operated in the third state-of-use. As shown in the figure, when the active semiconductor power switch SW is turned off, the first inducer L₁ starts to store energy to the first capacitor C₁; and, the second inducer L₂ continues transferring energy to the third inducer L₃ and obtains resonance with the second capacitor C₂. According to FIG. 7, the following equations (13) to (18) are obtained. When voltage resonance of the second capacitor C₂ becomes zero, the present invention enters into a fourth state-of-use.

### [State-of-Use 4]

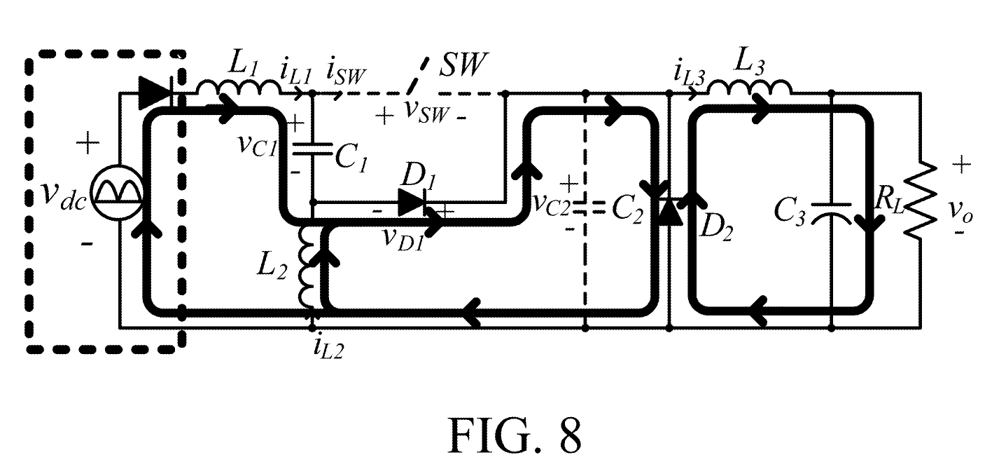

Please further refer to FIG. 8, which is a view showing an equivalent circuit operated in the fourth state-of-use. As shown in the figure, the second diode D₂ is turn on; the first inducer L₁ continues charging the first capacitor C₁; the second inducer L₂ flows current back through the first diode D₁ and the second diode D₂; and, an output inducer Lₒ outputs energy to the load R_{L}. According to FIG. 8, the following equations (19) to (24) are obtained. When the first inducer L₁ finishes releasing energy, the present invention enters into a third state-of-use. When the first inducer L₁ as an input of the present invention is operated under continuous conduction, a switching cycle is completed on finishing this state-of-use 4.

$$\begin{matrix}{L}_{1} \frac{d {i}_{L 1}}{d t} + {v}_{C 1} = {v}_{dc} & ( 19 ) \\ {L}_{2} \frac{d {i}_{L 2}}{d t} = 0 & ( 20 ) \\ {L}_{3} \frac{d {i}_{L 3}}{d t} = - {v}_{o} & ( 21 ) \\ {C}_{1} \frac{d {v}_{C 1}}{d t} = {i}_{L 1} & ( 22 ) \\ {C}_{2} \frac{d {v}_{C 2}}{d t} = 0 & ( 23 ) \\ {C}_{3} \frac{d {v}_{C 3}}{d t} = {i}_{L 3} - \frac{{V}_{o}}{{R}_{L}} & ( 24 )\end{matrix}$$

### [State-of-Use 5]

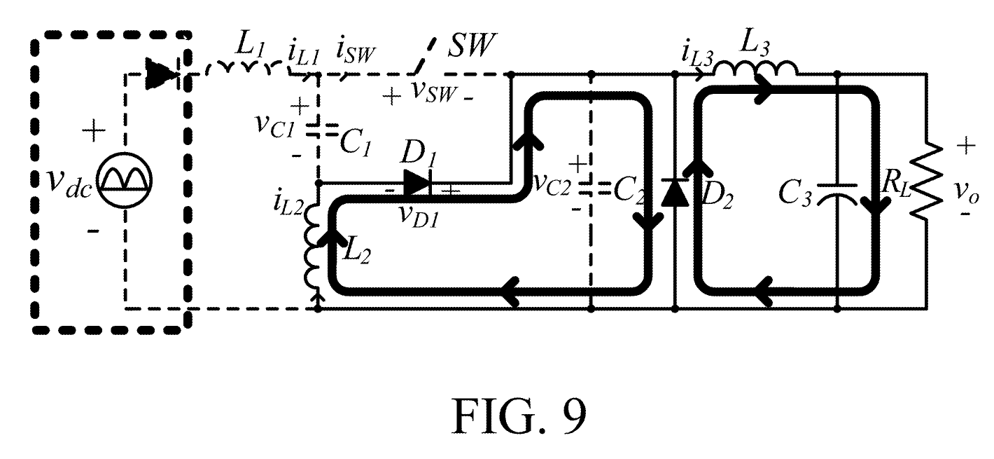

Please further refer to FIG. 9, which is a view showing an equivalent circuit operated in the fifth state-of-use. As shown in the figure, when the first inducer L₁ finishes releasing energy, the current becomes zero; the second inducer L₂ keeps flowing current back through the first diode D₁ and the second diode D₂; and, the output inducer L_{O} keeps outputting energy to the load R_{L} through the second diode D₂. According to FIG. 9, the following equations (25) to (30) are obtained. Until the active semiconductor power switch SW is turned on again, a switching cycle is completed.

$$\begin{matrix}{L}_{1} \frac{d {i}_{L 1}}{d t} = 0 & ( 25 ) \\ {L}_{2} \frac{d {i}_{L 2}}{d t} = 0 & ( 26 ) \\ {L}_{3} \frac{d {i}_{L 3}}{d t} = - {v}_{o} & ( 27 ) \\ {C}_{1} \frac{d {v}_{C 1}}{d t} = 0 & ( 28 ) \\ {C}_{2} \frac{d {v}_{C 2}}{d t} = 0 & ( 29 ) \\ {C}_{3} \frac{d {v}_{C 3}}{d t} = {i}_{L 3} - \frac{{V}_{o}}{{R}_{L}} & ( 30 )\end{matrix}$$

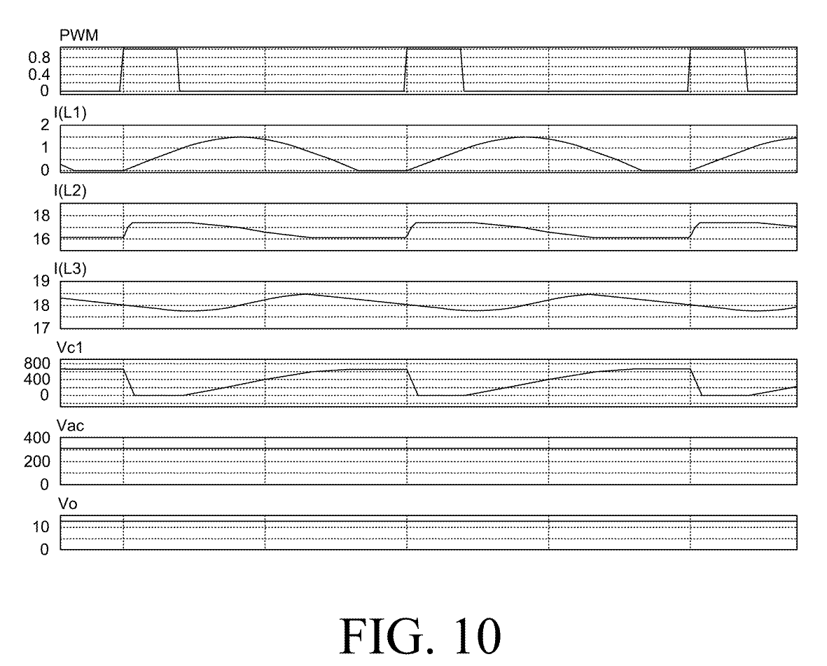

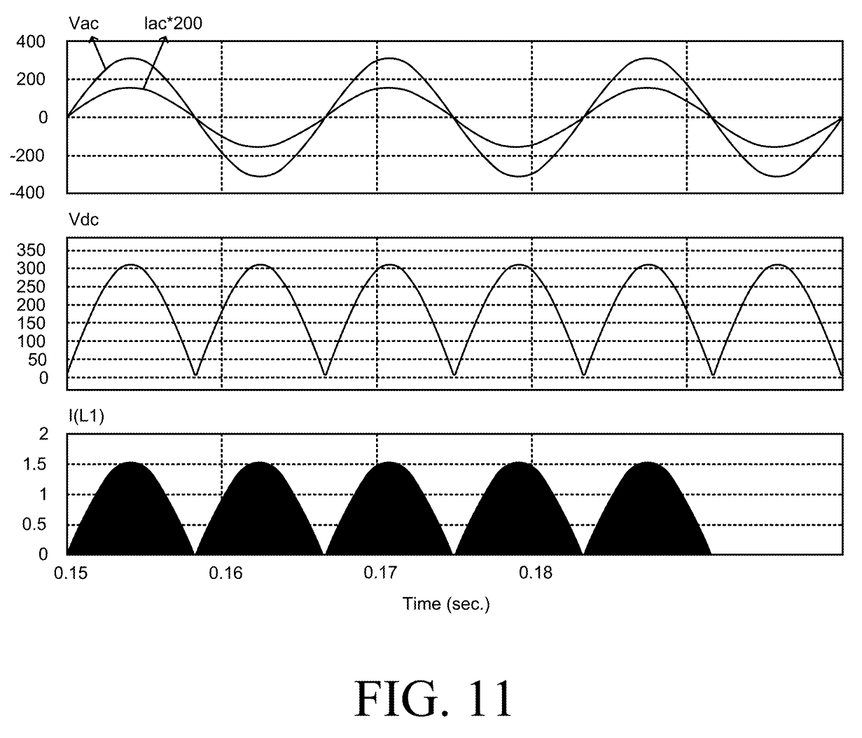

Please refer to FIG. 10 and FIG. 11, which are a first and a second views showing simulated key waves. As shown in the figures, the present invention uses a DC power source having waveform of absolute value of sine (with a circuit design as shown in FIG. 2), which has a peak voltage of 312V, an output DC voltage of 12V and an output power of 120 W. Therein, an input inducer L₁ has an inductance of 650 μH; a first capacitor C₁ for storing energy has a capacitance of 0.01 μF; a second inducer L₂ for storing energy has an inductance of 100 μH; a second capacitor C₂ has an capacitance of 0.047 μF; a third inducer L₃ for output has an inductance of 100 μH; a third capacitor C₃ for output has an capacitance of 1000 μF; an active semiconductor power switch SW is a metal-oxide-silicon field-effect transistor (MOSFET), SPP20N60S5; a diode bridge rectifier, KBU2506, is used; a first diode D₁, DSEP15-06A, and a second diode D₂, SRF20H40CT, are used; and, an active semiconductor power switch has a drive IC, HCPL3120, and a control IC, TL494. After simulation, in FIG. 10, a power factor at a power terminal v_{ac} is high up to 0.999 for achieving power factor correction with high step down voltage ratio. In FIG. 11, a 0.22 duty cycle is observed with key waves, which means that the present invention does not need very small duty cycle for high step down voltage ratio.

Accordingly, the present invention is a single-stage step down voltage converter with a DC bus capacitor having a small capacitance to convert a higher DC voltage at an input end into a lower DC voltage at an output end. The present invention is characterized in power factor correction and high step down voltage ratio, which does not need to use electrolytic capacitor and can be applied to multiple DC pairs. Number of components used in the present invention is greatly reduced by being applied with only one active switch for saving cost yet remaining high performance.

To sum up, the present invention is a single-stage single-switch voltage converter, where the converter is characterized in power factor correction and high step down voltage ratio; electrolytic capacitor is not necessary and multiple DC pairs can be applied to; and number of components used is greatly reduced by being applied with only one active switch for saving cost yet remaining high performance

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A single-stage single-switch voltage converter, said converter converting a high-voltage power into a low-voltage power to provide power to a low-voltage load, said converter comprising three inducers, three capacitors, two diodes and one active semiconductor power switch, said inducers comprising a first, a second and a third inducers, said capacitors comprising a first, a second and a third capacitors, said diodes comprising a first and a second diodes,
wherein two terminals at an input end of said converter are connected with a serial circuit; said serial circuit comprises said first inducer, said first capacitor and said second inducer; a positive voltage terminal and a negative voltage terminal of said first capacitor are connected with said active semiconductor power switch and said first diode, respectively, to connect to a first terminal of said third inducer; said first terminal of said third inducer is connected with said second capacitor and said second diode to connect to a common negative terminal of said input end and an output end of said converter; said third capacitor is connected with another terminal of said third inducer and said negative voltage terminal at said output end of said converter; and said another terminal of said third inducer is connected with said positive voltage terminal at said output end of said converter;
wherein, when said active semiconductor power switch is turned off, said first diode is turn on; a current of said first inducer charges said first capacitor with energy provided by said second inducer and said third inducer; said energy is rapidly increased through a voltage at said first capacitor and a current passed through said first inducer is limited to zero; and a high step down voltage ratio is thus obtained with power factor correction; and
wherein, when said active semiconductor power switch is turned on, said first diode is turned off; said first capacitor charges said second inducer; said first inducer stores energy; when said first capacitor finishes releasing energy, said second diode is turned off and said second inducer transfers energy to said second capacitor and said third inducer; and, until said active semiconductor power switch is turned on again, a switching cycle is completed.

2. The converter according to claim 1,
wherein said first capacitor has a capacitance smaller than 10 microfarad (μF).

3. The converter according to claim 1,
wherein, when said converter is used with an alternative current (AC) power source, a diode bridge rectifier is used to change a voltage waveform of said converter into a waveform of absolute value of sine; and an output current of said converter is always positive and said first inducer is operated with an input current having continuous conduction.

4. The converter according to claim 1,
wherein, when said converter is used with an direct current (DC) power source, output current of said converter is always positive and said first inducer is operated with an input current having non-continuous conduction.

5. The converter according to claim 1,
wherein, when said converter is used with an DC power source, output current of said converter is always positive and said first inducer is operated with an input current having continuous conduction.
